(19) United States
(12) Patent Application Publication
(10) Pub. No.: US 2012/0317277 A1
(43) Pub. Date: Dec. 13, 2012

(54) MONITORING APPARATUS, MONITORING METHOD, AND COMPUTER-READABLE MEDIUM

(75) Inventor: Akiko Hirahara, Kawasaki-shi (JP)

(73) Assignee: CANON KABUSHIKI KAISHA, Tokyo (JP)

(21) Appl. No.: 13/488,820

(22) Filed: Jun. 5, 2012

(30) Foreign Application Priority Data
Jun. 9, 2011 (JP) 2011-129547

(51) Int. Cl. G06F 15/173

(52) U.S. Cl. 709/224

(57) ABSTRACT

A monitoring apparatus which monitors a plurality of image forming apparatuses and transmits monitoring information, collected by monitoring, to a central management apparatus, comprises: collection unit configured to collect the monitoring information from the plurality of image forming apparatuses; storing unit configured to store the monitoring information collected; transmission unit configured to transmit the monitoring information stored by the storing unit to the central management apparatus; selection unit configured to accept selection of a data type, of the collected monitoring information, which is stored in a storage device within a local network; and output configured to output, as output data, data acquired from the monitoring information transmitted by the transmission unit in accordance with the data type selected for storing the output data in the storage device within the local network.

### BACKGROUND OP THE INVENTION

1. Field of the Invention

The present invention relates to a monitoring apparatus, a monitoring method, and a computer-readable medium and, more particularly, to a technique of transmitting counter information and device information of image forming apparatuses such as a printer and copying machine to a central management apparatus via a network.

2. Description of the Related Art

Currently, an image forming apparatus such as a printer or copying machine directly transmits various types of counter information and device information of the apparatus to a central management apparatus (central management server). Alternatively, a remote monitoring apparatus temporarily collects information of a plurality of image forming apparatuses and then transmits the information to the central management apparatus. A sales company (service center) or the like performs totalization/analysis/management of the data transmitted to the central management apparatus, and performs charge processing based on the information.

It is assumed that the sales company or the like uses the data transmitted from the remote monitoring apparatus to the central management apparatus. There are demands for system managers or the like at the respective bases where image forming apparatuses are installed to check transmission data of the apparatuses.

For example, Japanese Patent Laid-open No. 2006-350651 has proposed at method of securely transmitting, to a system manager, the same data as transmission data to a central management server. This method is designed to simultaneously e-mail encrypted data to the central management server and CC (Carbon Copy)—send the same data to the system manager. The system manager can browse decrypted data by downloading a data viewer as a set of a public key in the encrypted data and a private key as a key pair.

However, an enormous amount of data are sent to the central management apparatus. For example, the technique disclosed in Japanese Patent Laid-open No. 2006-350651 allows to use such data for the purpose of data monitoring, but gives no consideration to a system manager who wants to refer to only necessary data of the collected data. In consideration of the size of collected data as well, such data are designed to be browsed via a dedicated data viewer, and hence are not suited to searching and reprocessing of necessary data. Furthermore, in order to browse the data, the system manager needs to download the dedicated data viewer.

### SUMMARY OF THE INVENTION

The present invention therefore provides a technique of allowing to easily browse necessary data in sufficient consideration of convenience for the above system management user.

According to one aspect of the present invention, there is provided a monitoring apparatus which monitors a plurality of image forming apparatuses and transmits monitoring information, collected by monitoring, to a central management apparatus which manages information of the plurality of image forming apparatuses, comprising: collection unit configured to collect the monitoring information from the plurality of image forming apparatuses; storing unit configured to store the monitoring information collected by the collection unit; transmission unit configured to transmit the monitoring information stored by the storing unit to the central management apparatus; selection unit configured to accept selection of a data type, of the collected monitoring information, which is stored in a storage device within a local network; and output configured to output, as output data, data acquired from the monitoring information transmitted by the transmission unit in accordance with the data type selected by the selection unit for storing the output data in the storage device within the local network.

According to another aspect of the present invention, there is provided a monitoring method for a monitoring apparatus which monitors a plurality of image forming apparatuses and transmits monitoring information, collected by monitoring, to a central management apparatus which manages information of the plurality of image forming apparatuses, comprising the steps of: collecting the monitoring information from the plurality of image forming apparatuses; storing the collected monitoring information in a storing unit; transmitting the stored monitoring information to the central management apparatus; accepting selection of a data type, of the collected monitoring information, which is stored in a storage device within a local network; and outputting data acquired from the transmitted monitoring information in accordance with the selected data type as output data for storing the output data in the storage device within the local network.

According to the present invention, it is possible to provide a system manager or the like with necessary data selected from the data transmitted to a central management apparatus.

Further features of the present invention will become apparent from the following description of exemplary embodiments (with reference to the attached drawings).

### BRIEF DESCRIPTION OF THE DRAWINGS

FIG. 1 is a block diagram of a device management system;

FIG. 2 is a block diagram of an information processing apparatus including a monitoring apparatus 101;

FIG. 3 is a block diagram showing the arrangement of an image forming apparatus;

FIGS. 4A and 4B are block diagrams showing the detailed arrangement of the monitoring apparatus 101;

FIGS. 5A and 5B are flowcharts showing the operation of the monitoring apparatus 101;

FIG. 6 is a flowchart showing monitoring information collection processing by the monitoring apparatus 101;

FIG. 7 is a flowchart showing monitoring information transmission processing by the monitoring apparatus 101;

FIG. 8 is a flowchart showing search processing by the monitoring apparatus 101;

FIG. 9 is a flowchart showing periodic search processing by a monitoring apparatus 101 according to the third embodiment;

FIG. 10 is a view showing an example of an output data type selection UI;

FIG. 11 is a view showing an example of an output data format;

FIG. 12 is a view showing an example of a search UI;

FIG. 13 is a view showing an example of a search setting UI;

FIG. 14 is a view showing an example of an output data format; and

FIG. 15 is a flowchart showing periodic search processing by a monitoring apparatus 101 according to the fourth embodiment.

### DESCRIPTION OF THE EMBODIMENTS

Embodiments for carrying out the present invention will be described below with reference to the accompanying drawings.

### First Embodiment

### [System Arrangement]

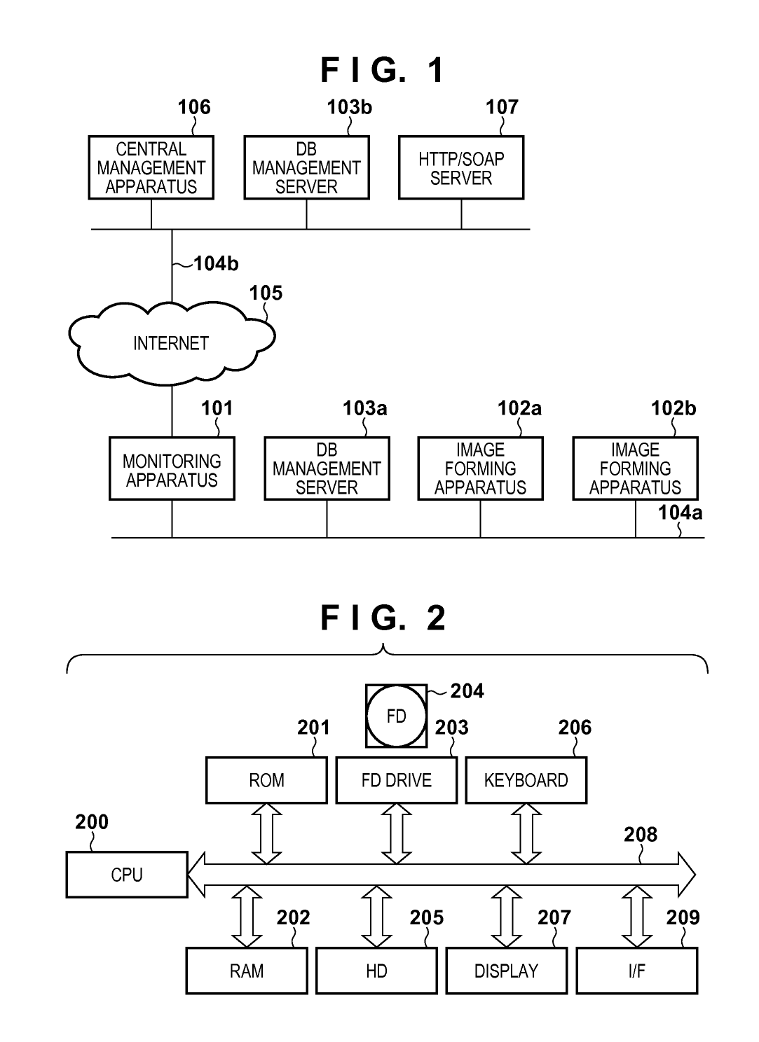

FIG. 1 is a block diagram showing the schematic arrangement of a device management system according to this embodiment. On the base side subjected to monitoring, a monitoring apparatus 101 which manages device information and device states of a plurality of image forming apparatuses 102a, 102b, . . . , as management targets is communicatively connected to them via a LAN 104a (so the monitoring apparatus is arranged to communicate with the plurality of image forming apparatuses). The monitoring apparatus 101 is connected to the Internet 105 via the LAN 104a, and can communicate with the service center side including a central management apparatus 106. Assume that in this embodiment, the side (on the LAN 104b side) on which the central management apparatus 106 is placed is the service center side, and the side (LAN 104a side) on which the monitoring apparatus 101 is placed is the base side. The embodiment exemplifies the case in which the respective networks are connected via the Internet 105. However, the present invention is not limited to this, and may have an arrangement in which they are connected via another type of network.

The service center side which performs monitoring includes the central management apparatus 106, a DB management server 103b, an HTTP/SOAP server 107 capable of performing HTTP(S) and SOAP communication, and a LAN 104b.

The central management apparatus 106 unitarily (so the central management apparatus alone) manages and collects information of the respective image forming apparatuses as monitoring targets, and provides information, as needed. The DB management server 103b on the service center side functions as databases of various types of information, and holds various types of information collected in accordance with instructions from the central management apparatus 106.

The HTTP/SOAP server 107 is connected to the Internet 105 via the LAN 104b, and transmits the data received from the Internet 105 to the central management apparatus 106.

Referring to FIG. 1, in this embodiment, the respective servers on the service center side are formed by different apparatuses. However, the servers may be implemented within the same apparatus, or the same functions may be implemented by a plurality of physical apparatuses in a distributed manner.

The monitoring apparatus 101 on the base side subjected to monitoring will be described in more detail. The monitoring apparatus 101 stores, for each image forming apparatus, various types of counter values indicating the number of copies printed so far, the number of pages printed, so far, and the like, device information, and device states. Conceivable methods of holding information may include holding various types of information, in a DB management server 103a periodically or as needed, which are acquired by the monitoring apparatus 101 from the respective image forming apparatuses.

In general, with regard to acquisition timings of various types of information from the monitoring apparatus 101, counter values, environmental information of devices, and the like are periodically acquired from the image forming apparatuses. In addition, when a device is set in an error/warning state, corresponding information is acquired from the image forming apparatus, as needed. Furthermore, when a request which needs a response from a remote apparatus or the central management apparatus 106 is generated upon UI (User Interface) operation on an image forming apparatus, corresponding information is acquired from the image forming apparatus, as needed.

Information acquired from each image forming apparatus and held in the DB management server 103a on the base side is transmitted to the service center side by using HTTP(S) or SOAP periodically or as needed. In this case, HTTP(S) (Hyper Text Transfer Protocol (over Secure Socket Layer)) or SOAP (Simple Object Access Protocol) represent protocols used for communication between the respective apparatuses.

Referring to FIG. 1, in this embodiment, the monitoring apparatus 101 and the DB management server 103a on the base side are formed by different apparatuses. However, they may be implemented within the same apparatus.

### [Device Arrangement]

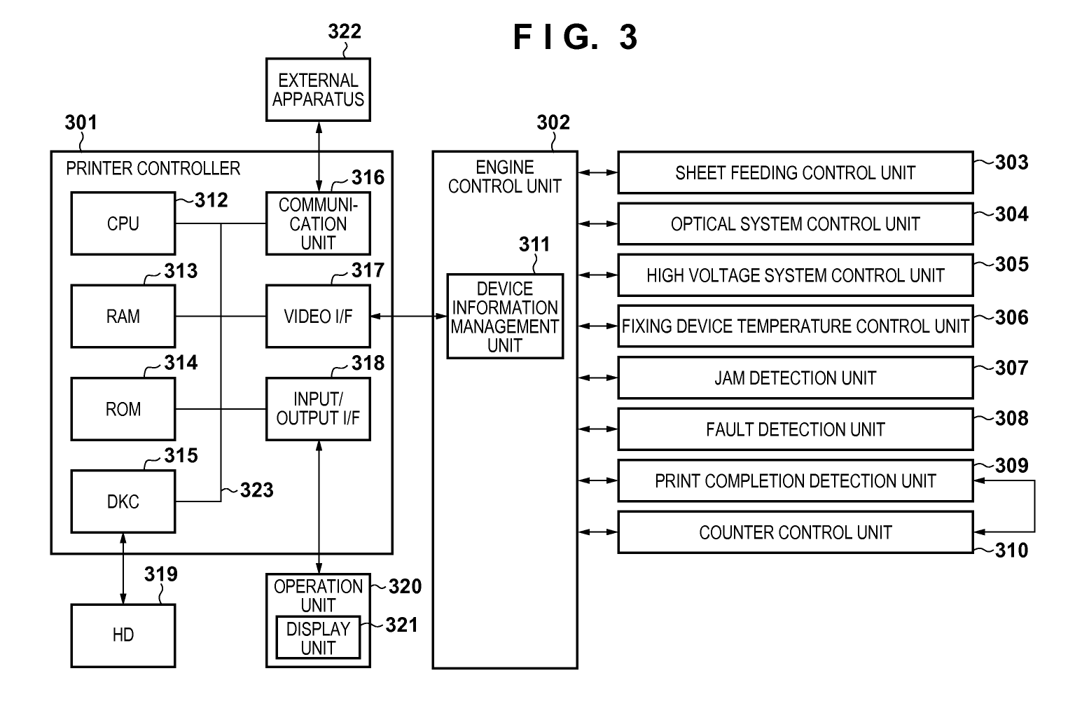

FIG. 2 is a block diagram for explaining the arrangement of the information processing apparatus according to this embodiment. This arrangement corresponds to that of the monitoring apparatus 101, central management apparatus 106, and HTTP/SOAP server 107 in FIG. 1. Referring to FIG. 2, a CPU 200 is the control unit of an information processing apparatus, which executes application programs, OS (Operating System), device monitoring program according to the present invention, and the like, which are stored in a hard disk (HD) 205. At this time, the CPU 200 performs control to temporarily store information, files, and the like necessary for the execution of a program in a RAM 202.

Assume that the CPU implements the processing in each step in each flowchart (to be described later) by executing processing based on program codes stored in storing units as various storing units such as storing units 201 and 204 and the storing unit 205.

The ROM 201 as a storing unit stores programs such as a basic I/O program and various types of data such as setting data. The RAM 202 as a temporary storing unit functions as the main memory, work area, and the like of the CPU 200.

A floppy® disk (FD) drive 203 as a storage medium reading unit can load a program or the like stored in an FD 204 as a storage medium via the Floppy® disk (FD) drive 203 into the computer system. Note that a storage medium to be used is not limited to an FD, and it is possible to arbitrarily use a CD-ROM, CD-R, CD-RW, PC card, DVD, IC memory card, MO, memory stick, or the like. The floppy® disk (FD) 204 as a storing unit is a storing unit storing computer-readable programs.

The hard disk (HD) 205 is one of external storing units, which functions as a large-capacity memory. The HD 205 stores application programs, OS, associated programs, and the like. A keyboard 206 as an instruction input unit inputs/instructs, for example, monitoring settings to the monitoring apparatus.

A display 207 as a display unit displays setting instructions input from the keyboard 206 and a monitoring state. In practice, for example, a graphic card interprets a drawing command issued by an application via an OS mechanism and converts it into analog signal or digital signal, and the display 207 displays the corresponding information. Display control in this embodiment includes the processing of issuing a drawing command via the OS to make the display unit display the corresponding information.

A system bus 208 controls the flow of data in the information processing apparatus. An interface (I/F) 209 is an input/output unit. The information processing apparatus exchanges data with an external apparatus via the I/F 209.

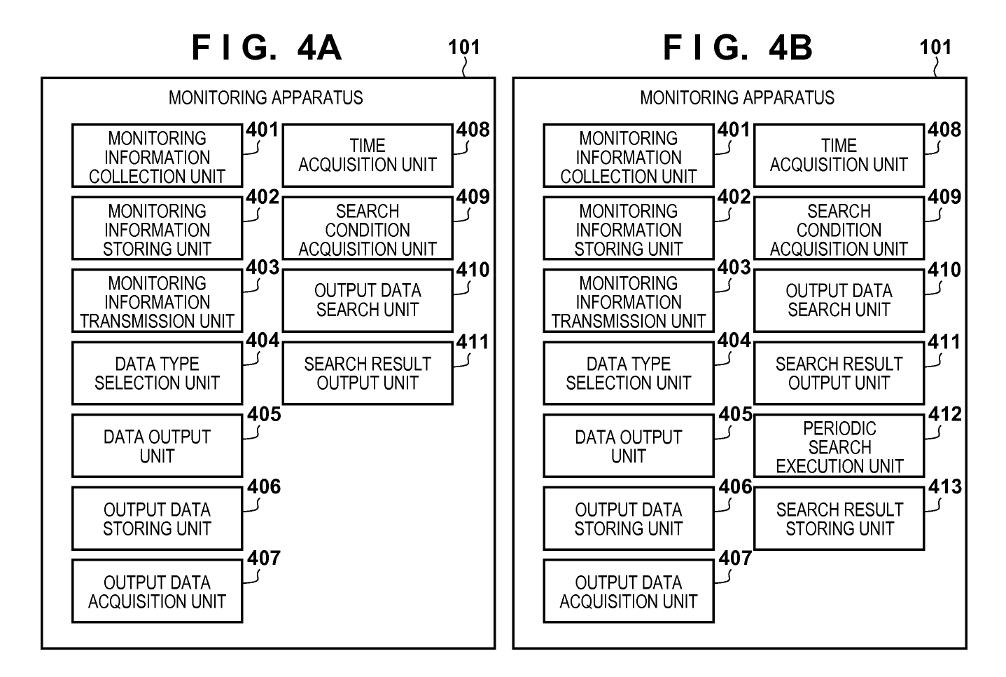

FIG. 3 is a block diagram of the printer control unit of an image forming apparatus 102 and its peripheral portion in this embodiment. Referring to FIG. 3, a printer controller 301 includes an external apparatus 322 (corresponding to the monitoring apparatus 101 or the like in FIG. 1) such as a host computer and a communication unit 316 for executing transmission/reception of various types of data by using a predetermined protocol. The printer controller 301 further includes a video I/F 317 for performing communication, receiving image data, and expanding the received image data into information which can be printed by a printer. In addition, the video I/F 317 serves to perform transmission/reception of signals and serial communication with an engine control unit 302 (to be described later).

A CPU 312 of the image forming apparatus 102 comprehensively controls access to various devices connected to a system bus 323 based on control programs stored in a ROM 314 or an HD (external memory) 319. The CPU 312 outputs an image signal as output information to the printer engine connected via the video I/F 317.

A RAM 313 functions as the main memory, work memory, and the like of the CPU 312. A memory controller (DKC) 315 controls access to an external memory such as the HD 319 which stores a boot program, various types of applications, font data, user files, and editing files.

A operation unit 320 includes a display unit 321 and a keyboard. The operation unit 320 provides information to an operator and accepts input instructions from the operator via an input/output I/F 318.

The engine control unit 302 exchanges signals with the printer controller 301, and controls each unit of the printer engine via serial communication. A sheet feeding control unit 303 executes sheet feeding including feeding a print sheet and discharging the sheet after printing based on instructions from the engine control unit 302. An optical system control unit 304 executes driving of a scanner motor and ON/OFF control of a laser based on instructions from the engine control unit 302.

A high voltage system control unit 305 performs high voltage output control necessary for an electrophotographic process including charging, developing, and transferring based on instructions from the engine control unit 302. A fixing device temperature control unit 306 performs temperature control on the fixing device, abnormality detection in the fixing device, and the like based on instructions from the engine control unit 302.

A jam detection unit 307 detects a feeding failure of a sheet being fed. A fault detection unit 303 detects a fault fn a functional unit in the printer. A print completion detection unit 309 detects that printing has been normally performed, and notifies the engine control unit 302 of the corresponding information. A counter control unit 310 updates various types of counter information after printing.

The engine control unit 302 includes a device information management unit 311 which manages information of each unit of the printer engine. In the device information management unit 311, in response to a request from the external apparatus 322, for example, the engine control unit 302 acquires a counter value from the counter control unit 310 and transfers it to the video I/F 317. With this operation, the counter information is transmitted to the external apparatus 322 via the video I/F 317 and the communication unit 316. In addition, when receiving an information acquisition request from the external apparatus 322, the engine control unit 302 acquires information from each unit, as needed, and provides the information via the device information management unit 311.

Furthermore, the device information management unit 311 manages jam information notified from the jam detection unit 307 and error information notified from the fault detection unit 308. The device information management unit 311 transmits these pieces of information to the external apparatus 322 via the video I/F 317 or the like, if the external apparatus 322 has issued an event notification request in advance.

In addition, as an image forming apparatus according to this embodiment, it is possible to use a laser beam printer using the above electrophotographic system, an ink-jet printer using the ink-jet printing system, a thermal head printer using the thermal transfer printing system, a copying machine, or the like.

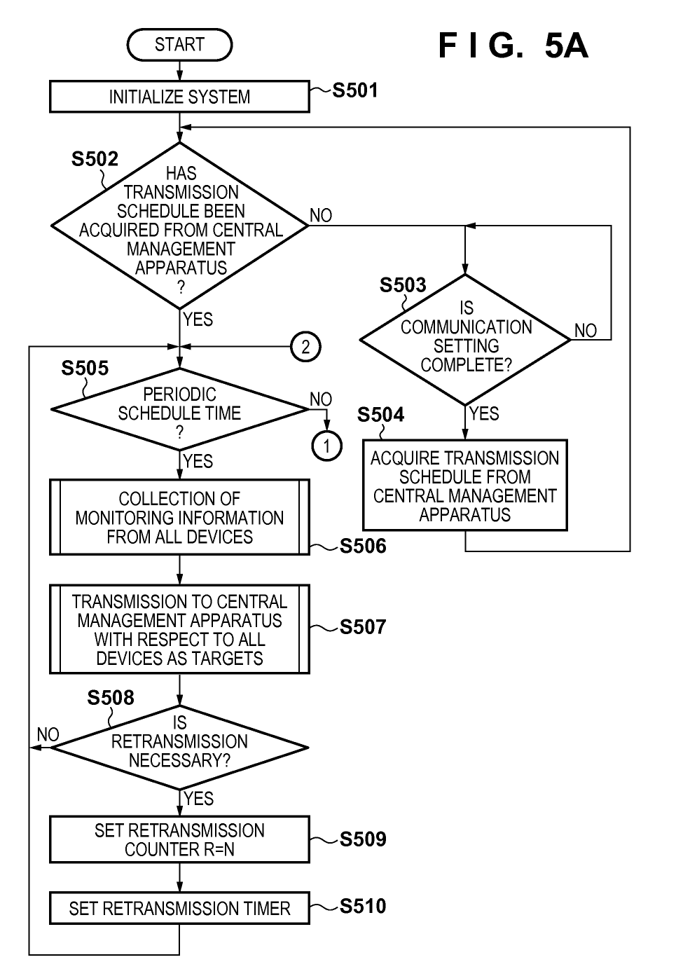

FIG. 4A shows the detailed internal arrangement of the monitoring apparatus 101 according to this embodiment. Assume that, in this embodiment, the processing performed by the respective components shown in FIG. 4A is implemented by causing the CPU provided in the monitoring apparatus 101 shown in FIG. 1 to load various control programs stored in a ROM and a nonvolatile storing unit such as a hard disk and executing the programs.

A monitoring information collection unit 401 collects monitoring information from the image forming apparatuses 102a and 102b periodically or at designated timings. A monitoring information storing unit 402 stores the monitoring information of each image forming apparatus, which is collected by the monitoring information collection unit 401, in the DB management server 103a.

A monitoring information transmission unit 403 generates transmission data from the monitoring information stored in the DB management server 103a, and transmits the data to the central management apparatus 106. A data type selection unit 404 selects a data type which the user wants to output. A data output unit 405 outputs a data type, of the information stored in the DB management server 103a, which is selected by the data type selection unit 404.

An output data storing unit 406 stores the output data output from the data output unit 405 in a file format or in the DB management server 103a. An output data acquisition unit 407 acquires output data stored by the output data storing unit 406 for search operation. A time acquisition unit 408 acquires time information including dates such as data collection date and time from monitoring information and data transmission date and time to the central management apparatus 106.

A search condition acquisition unit 409 acquires search conditions such as a time condition for output data. An output data search unit 410 executes a search in accordance with the search conditions acquired by the search condition acquisition unit 409. A search result output unit 411 outputs the search result obtained by the output data search unit 410.

### [Processing Procedure]

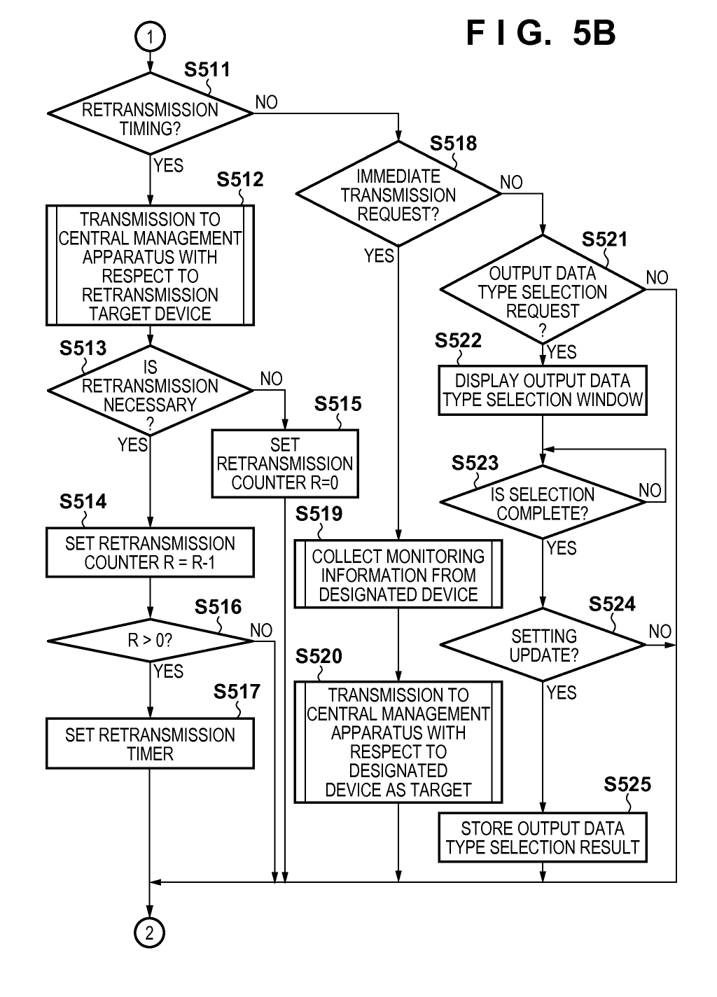

A processing procedure according to this embodiment will be described with reference to the flowcharts of FIGS. 5A and 5B. Assume that the processing in each step in the flowcharts of FIGS. 5 to 9 is implemented by causing the CPU provided in the monitoring apparatus 101 shown in FIG. 1 to load and execute various control programs stored in a ROM and a nonvolatile storing unit such as a hard disk.

In this embodiment, the monitoring apparatus 101 acquires a periodic schedule from the central management apparatus 106 side (service center side) and collects monitoring information from all registered devices (registered image forming apparatuses) in accordance with the periodic schedule. Assume that the monitoring apparatus 101 transmits the collected monitoring information to the central management apparatus 106. Alternatively, a periodic schedule may be set on the base side.

In addition, in this embodiment, upon acquiring monitoring information, the monitoring apparatus 101 immediately transmits the information to the central management apparatus 106. However, it is possible to separately generate an acquisition schedule of information from each image forming apparatus and a transmission schedule of information to the central management apparatus 106. In addition, the flowcharts of FIGS. 5A and 5B state that the processing starts when the system is powered on. However, the present invention is not limited to this. The processing procedure may be started at an arbitrary timing based on an instruction from a user.

An application describes an example in which information is immediately transmitted in accordance with a user request or the like other than a periodic schedule.

First of all, the monitoring apparatus 101 initializes the system upon power activation (step S501). More specifically, in initialization processing, the monitoring apparatus 101 loads an information table associated with registered device information, and performs initialization of variables and the like. Furthermore, the monitoring apparatus 101 performs, as one operation in initialization processing, determination whether a transmission schedule has been acquired from the central management apparatus 106 (step S502).

If no transmission schedule has been acquired (NO in step S502), the monitoring apparatus 101 determines whether communication setting for communication with the central management apparatus 106 has been completed (step S503). If communication setting has not been completed (NO in step S503), the monitoring apparatus 101 stands by until communication setting is complete. If communication setting has been completed (YES in step S503), the monitoring apparatus 101 acquires a transmission schedule from the central management apparatus 106 (step S504). The process then returns to step S502. If a transmission schedule is acquired (YES in step S502), the monitoring apparatus 101 determines that initialization processing is complete, and enters the loop of processing an external request and detected information.

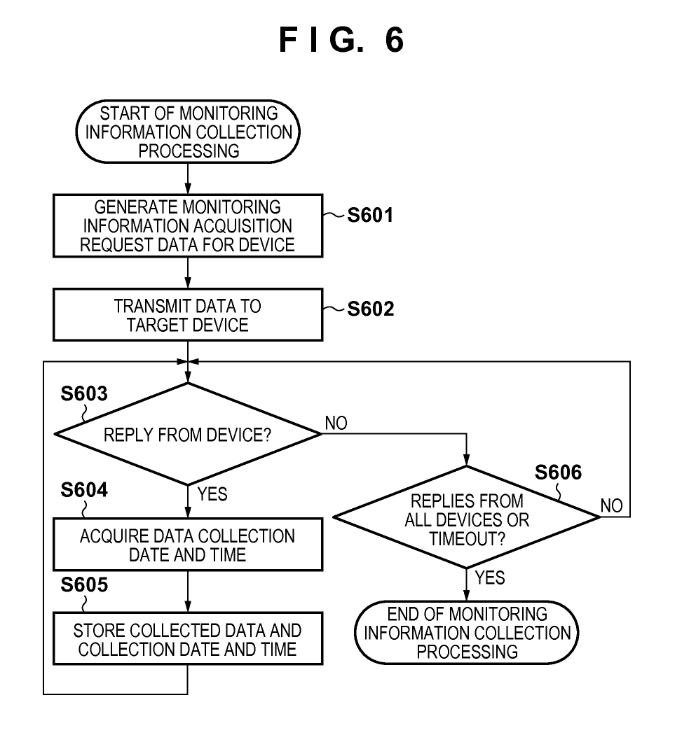

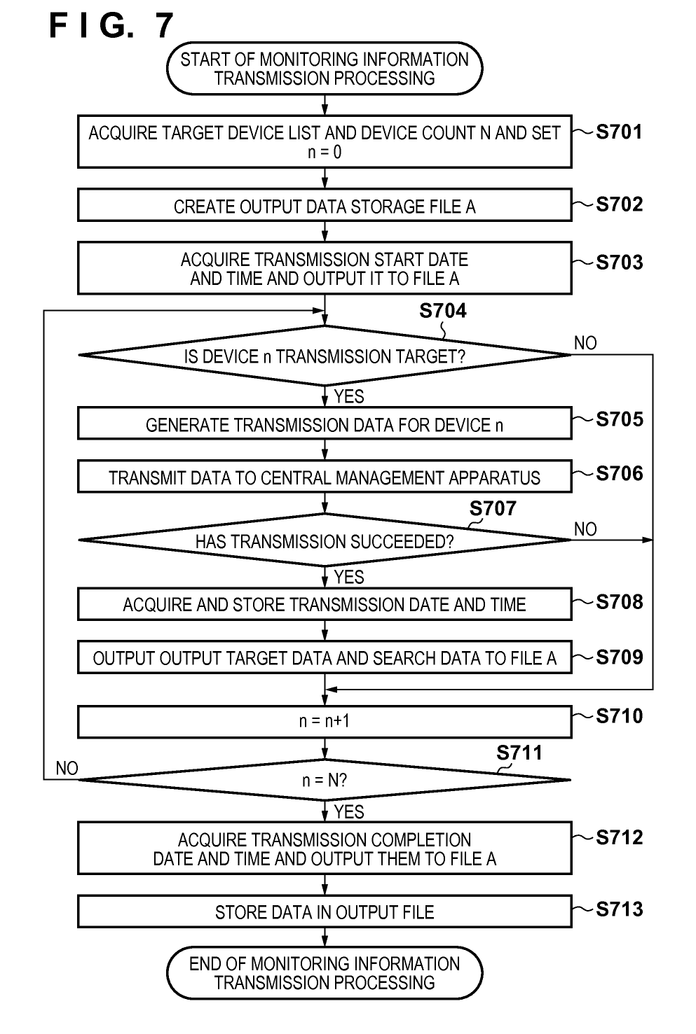

First of all, the monitoring apparatus 101 determines whether the current time is a periodic schedule time (step S505). In this case, the periodic schedule time indicates the time when collection processing/transmission processing is performed, based on the transmission schedule information acquired from the central management apparatus 106. If the current time is a periodic schedule time (YES in step S505), the monitoring information collection unit 401 of the monitoring apparatus 101 acquires monitoring information from all registered devices (step S506). This monitoring information acquisition processing will be described later with reference to FIG. 6. If the monitoring information acquisition processing in step S506 is complete, the monitoring information transmission unit 403 of the monitoring apparatus 101 performs transmission processing to the central management apparatus 106 with respect to all the registered devices (step S507). Transmission processing to the central management apparatus 106 will be described later with reference to FIG. 7.

If the transmission processing in step S507 is complete, the monitoring apparatus 101 determines, based on the transmission result, whether retransmission on the monitoring information to the central management apparatus 106 is required (step S508). In this case, the monitoring apparatus 101 determines that retransmission is required, when, for example, connection fails between apparatuses due to a communication state or some kind of error occurs during transmission to the central management apparatus 106.

Upon determining that retransmission of the monitoring information is required (YES in step S508), the monitoring apparatus 101 sets a maximum retransmission count N (a fixed value or set value in the system) in a retransmission counter R for retransmission target devices (step S509). The retransmission target device indicates the device which is source of acquisition of the monitoring information of which the retransmission is required. The monitoring apparatus 101 then sets the retransmission timer (step S510). In this case, a predetermined value is set in the retransmission timer, and retransmission processing is performed at the retransmission timing designated by the retransmission timer (step S512). In this embodiment, the same maximum retransmission count is set for schedule transmission tor all the registered devices. Alternatively, however, a maximum retransmission count may be set tor each device. If retransmission is not required (NO in step S508), the process returns to step S505.

If the current time is not a periodic schedule time (NO in step S505), the monitoring apparatus 101 determines whether the retransmission timer is set in a signaling state (that is, the retransmission timing) (step S511). If the current timing is the retransmission timing (YES in step S511), the monitoring information transmission unit 403 of the monitoring apparatus 101 performs, with respect to the retransmission target device, transmission processing to the central management apparatus 106 as retransmission of the monitoring information (step S512). Transmission processing to the central management apparatus 106 will be described later with reference to FIG. 7.

After the completion of the transmission processing in step S512, the monitoring apparatus 101 determines, based on the transmission result, whether retransmission is required, as in step S508 (step S513). If retransmission is required (YES in step S513), the monitoring apparatus 101 decrements the retransmission counter by one (step S514). The monitoring apparatus 101 then determines whether the retransmission counter is (has a) positive value (step S516). If the retransmission counter is (has a) positive value (YES in step S516), the monitoring apparatus 101 sets the retransmission timer (step S517). The process then returns to step S505.

If retransmission is not required (NO in step S513), the monitoring apparatus 101 sets the retransmission counter to 0 (step S515). The process then returns to step S505. If the retransmission counter is not positive value (that is, the retransmission counter is 0) (NO in step S516). The process then returns to step S505.

If the current timing is not the retransmission timing (NO in step S511), the monitoring apparatus 101 determines whether immediate transmission request for monitoring information with respect to a designated device has been received as a user request or the like (step S518). Note that this system may be configured to allow the user to issue an immediate transmission request as one menu via the operation unit 320 or may issue a request based on an instruction from the central management apparatus 106 side.

If an immediate transmission request has been received (YES in step S518), the monitoring information collection unit 401 of the monitoring apparatus 101 acquires monitoring information from the designated device (step S519). The monitoring information acquisition processing in this case will be described later with reference to FIG. 6. If the monitoring information acquisition processing is complete in step S519, the monitoring information transmission unit 403 of the monitoring apparatus 101 performs transmission processing to the central management apparatus 106 with respect to the designated device (step S520). The process then returns to step S505. Transmission processing in this case will be described later with reference to FIG. 7.

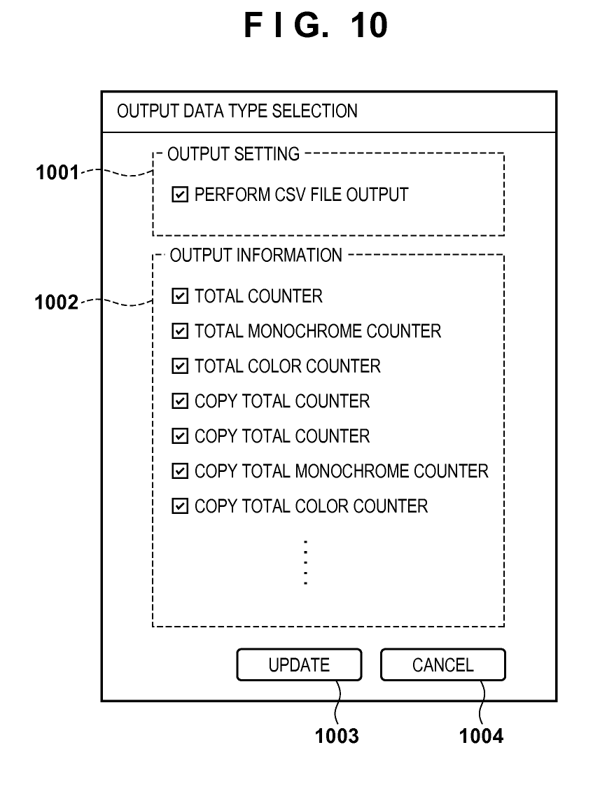

If no immediate transmission request has been received (NO in step S518), the monitoring apparatus 101 determines whether an output data type selection request has been received (step S521). Note that this system is configured to allow the user to issue an output data type selection request as one menu via the operation unit 320. If an output data type selection request has been received (YES in step S521), the monitoring apparatus 101 displays an output data type selection window like that shown in FIG. 10 as a user interface via the display unit 321 (step S522).

An output data type selection window will be described with reference to FIG. 10. This window includes output setting 1001 for determination whether CSV (Comma Separated Values) file output is performed. When the check of this setting is “ON”, selective information output operation is performed. If the check is “OFF”, this operation is not performed. In addition, in this embodiment, the output destination is limited to a CSV file. However, it is possible to use another file format or perform DB output.

If output setting 1001 is “ON”, the apparatus displays a list of data types (output information 1002) for the selection of output information. FIG. 10 shows, for example, a list of charge counters as check boxes. However, the apparatus may display any monitoring information. In addition, the designation format to be used is not limited to a check box, and it is possible to perform input operation using an edit box or the like. The user selects information to be output on an output information 1002 field, and presses an update button 1003.

Referring to FIG. 10, when the user pressed the update button 1003 or a cancel button 1004, the apparatus determines that selection is complete. The output data type selection window shown in FIG. 10 is an example, and the arrangement and items are not limited those shown in FIG. 10. For example, the window shown in FIG. 10 is configured to allow the user to select the type of data to be output by individually using check boxes. However, the apparatus may allow the user to input a setting file which defines the type of data to be output in advance. In addition, the window in FIG. 10 is configured to allow the user to designate information of the information mainly handled by an image forming apparatus which is associated with charge (chargeable), and may further include device management information and the like.

If the selection of an output data type has not been completed (NO in step S523), the monitoring apparatus 101 stands by until the completion of the selection (until the user presses one of the buttons in FIG. 10). If the selection of an output data type is complete (YES in step S523), the monitoring apparatus 101 determines whether a setting is updated (step S524). If the user presses the update button 1003 in FIG. 10, the apparatus can determine that the setting is updated. If the setting is updated (YES in step S524), the monitoring apparatus 101 stores the setting content as a selection result (step S525). The process then returns to step S505. The setting content is stored in a setting file, program, or database (DB), and is referred to at the time of output operation, thereby narrowing down output information.

If the setting is not updated (NO in step S524), the process returns to step S505. If the user has pressed the cancel button. 1004 shown in FIG. 10, the apparatus can determine that no setting has been updated.

### [Monitoring Information Collection Processing]

Monitoring information collection processing will be described next with reference to FIG. 6. This processing corresponds to the processing in steps S506, and S519 in the processing procedure shown in FIGS. 5A and 5B.

The monitoring apparatus 101 generates monitoring information acquisition request data to be transmitted to a device (image forming apparatus) as a monitoring information acquisition target (step S601). The monitoring apparatus 101 transmits the monitoring information acquisition request to the device as the monitoring information acquisition target (step S602), and determines whether there is a reply from the device (step S603). If there is a reply from the device (YES in step S603), the monitoring apparatus 101 causes the time acquisition unit 408 to acquire the date and time at the corresponding point of time, and sets it as a data acquisition date and time (step S604). In this embodiment, the data collection date and time is added, as data for a data search, to collected data. This associates the data collection date and time with collected data. This makes it possible to search for output information by using the date and time designation acquired from the device.

Upon acquiring the data collection date and time in step S504, the monitoring apparatus 101 stores the data collected from the device and the collection date and time in a DB or the like (step S605). The process then returns to step S603.

If there is no reply in response to a monitoring information acquisition request (NO in step S603), the monitoring apparatus 101 determines whether it has received replies from all the devices to which monitoring information acquisition requests have been transmitted, or timeouts have occurred (step S606). If the monitoring apparatus 101 has received no replies from all the devices to which monitoring information acquisition requests have been transmitted, or predetermined periods of time have elapsed since the transmission of the requests (NO in step S606), the process returns to step S603. If YES in step S606, the monitoring apparatus 101 terminates the monitoring information collection processing. Assume that a predetermined time for the determination of a timeout in step S606 is defined in advance.

### [Transmission Processing]

Transmission processing from the monitoring apparatus 101 to the central management apparatus 106 will be described next with reference to FIG. 7. This processing corresponds to the processing in steps S507, S512, and S520 shown in the processing procedure in FIGS. 5A and 5B.

The monitoring apparatus 101 acquires a device list of transmission targets to (from) the central management apparatus 106 and a target device count N, and initializes a variable n used for operation on the device list to 0 (step S701). The monitoring apparatus 101 creates a file A for storing output data (step S702). The file A stores selected information according to this embodiment (for example, information of a data type selected on the output information 1002 in FIG. 10). The monitoring apparatus 101 causes the time acquisition unit 408 to output the acquired information as a transmission start date and time to the file A at the time of creation of the file A (step S703).

The monitoring apparatus 101 then determines whether a device n (the nth device in the device list) is a transmission target (step S704). This determination may be performed by determining whether, for example, a data transmission date and time to be stored for each device in step S708 (the previous transmission date and time at this time) falls within a predetermined time, or by comparing the data collection date and time acquired in step S604 with the previous transmission date and time. In the latter case, if the data collection date and time is newer than the previous transmission time, the apparatus determines that the device is a transmission target.

If the device n is not a transmission target (NO in step S704), the process advances to step S710. If the device n is a transmission target (YES in step S704), the monitoring apparatus 101 generates transmission data for the central management apparatus 106 with respect to the device n (step S705). The monitoring apparatus 101 then transmits the generated transmission data to the central management apparatus 106 (step S706).

The monitoring apparatus 101 determines whether the transmission of the transmission data to the central management apparatus 106 has succeeded (step S707). If the transmission has failed (NO in step S707), the process advances to step S710. If the transmission has succeeded (YES in step S707), the monitoring apparatus 101 causes the time acquisition unit 408 to acquire the current time and stores it in the DB upon associating it as data transmission date and time with the transmission data (step S708). In this embodiment, a transmission completion time is set as a data transmission date and time. However, a transmission start time may be set as a data transmission date and time. Alternatively, each piece of time information may be acquired and stored.

The monitoring apparatus 101 outputs the data of the data type selected by a user via the data type selection unit 404 and search data to the file A (step S709).

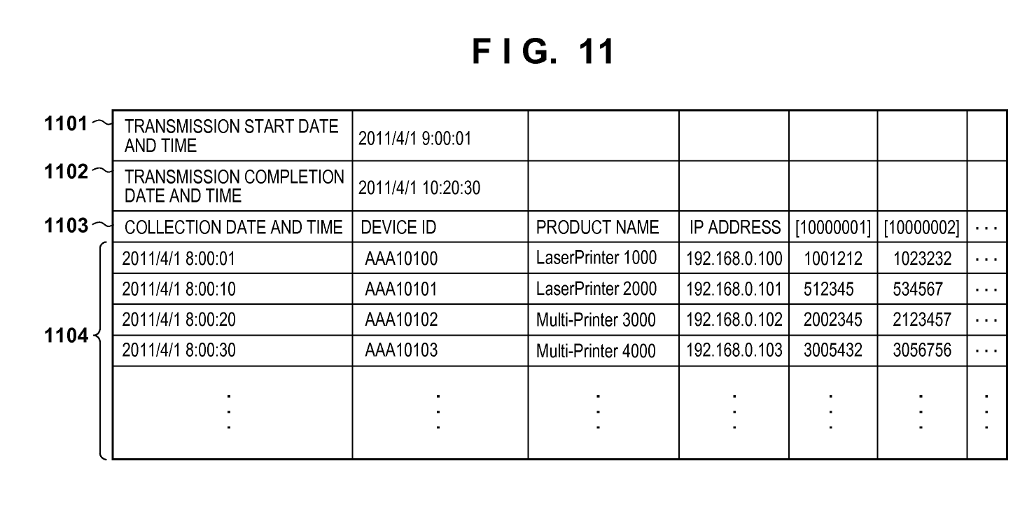

FIG. 11 shows an example of the arrangement of the output file A, in which the apparatus outputs transmission start date and time 1101 obtained in step S703 to the first row; the transmission completion date and time 1102 obtained in step S712 to the second row; each data item (data type 1103) to the third row; and data 1104 of each device to the fourth and subsequent rows. The data items of each device include the collection date and time of data from each device on the first column, a device ID for identifying each device on the second column, the product name of each device on the third column, the IP address of each device on the fourth column, and collected data from each device on the fifth and subsequent columns.

As a collection date and time, the data stored in the DB in step S605 in FIG. 6 is acquired and used. In this embodiment, collected data are represented by data IDs such, as [10000001] and [10000002], and are output as, for example, charge counter numbers. A device ID, product name, IP address, and the like each are information for identifying the device, and are used as search data. In addition to these pieces of information, other information such as a MAC address may be added. The apparatus may be configured to allow to variably make settings to output a specific type of information (so to allow settings, to output a specific type of information, to be variably made). A transmission start date and time, transmission completion date and time, and collection date and time are used as search data. Note that the arrangement of an output file (for example, the CSV format) shown in FIG. 11 is an example, and other arrangements may be used.

After step S709, the monitoring apparatus 101 increments the variable n (step S710). The monitoring apparatus 101 then determines whether n is equal to the target device count N (that is, the processing for the target devices is complete) (step S711). If n is not equal to the target device count N (NO in step S711), the process returns to step S704. If n is equal to the target device count N (YES in step S711), the monitoring apparatus 101 sets the time acquired by the time acquisition unit 408 as a transmission completion date and time, and outputs the corresponding information to the file A (step S712). The monitoring apparatus 101 stores the created file A (step S713), and terminates the monitoring information transmission processing.

This embodiment performs file storage processing at the completion of a series of processing operations. Alternatively, however, the embodiment may be configured to perform storage processing for every file output operation. In addition, in the procedure in FIG. 7, the apparatus outputs information associated with a plurality of devices to one file A at the timing of transmission to the central management apparatus. However, the present invention is not limited to this. One file may be created for one device. It is also assumed that the created file A is stored in a database (for example, the DB management server 103a) belonging to the network on the base side (local network). In addition, the apparatus may be configured to periodically delete collected monitoring information or the data in the stored file A and the like or to transfer such data to another apparatus within the local network.

### [Search Processing (General-Purpose Application)]

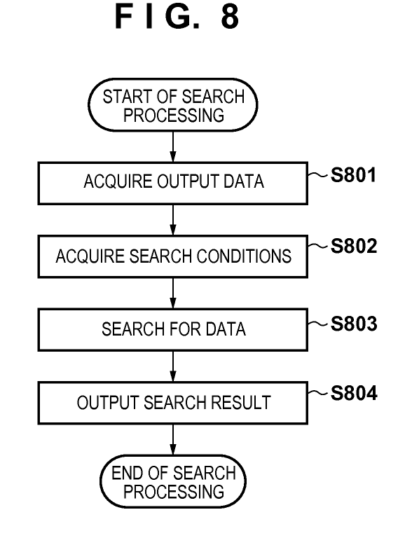

Search processing will be described next with reference to FIG. 8. The user issues an instruction to execute search processing at an arbitrary timing. The apparatus then executes the processing based on the instruction. The format of an output file in this embodiment is the CSV format. Since this is a general file format, there are many types of general-purpose applications (not shown) corresponding to CSV and a search function. FIG. 8 shows a procedure for the use of such a general-purpose application. Note that the CPU or the like executes the general-purpose application in the apparatus in which the application is installed.

First of all, the general-purpose application acquires output data (for example, the file A) from a storage folder in an output file as a search target (step S801). The general-purpose application then acquires a search condition from an input from the user using a search condition input UI or the like by using the search function of the general-purpose supplication (step S802). The general-purpose application performs a data search processing with search data of the search target by executing the search function (step S803). The general-purpose application outputs the search result (step S804).

Assume that the apparatus searches for charge counter information. In this case, if the apparatus performs charge processing in accordance with a collection date and time from a device, the apparatus refers to the “collection date and time” item. When performing charge processing in accordance with the data transmission date and time to the central management apparatus 106, the apparatus may refer to “transmission start date and time” or “transmission completion date and time”. It is possible to perform such data search by using a known search technique, for example, the Grep technique (pattern matching). Since this technique is irrelevant to the scope of the present invention, a description of it will be omitted.

With the processing described above, it is possible to provide only data, of the data transmitted to the central management apparatus 106, which is selected by the user (for example, a management user of the LAN system), in a searchable form.

As the first effect of this embodiment, it becomes possible to selectively provide the system management user with a part of data transmitted to the central management apparatus. The second effect is that output data is made to include search data to facilitate reprocessing and data search. The third effect is that since necessary data can be selectively stored, no excessive load is imposed on the storage area.

### Second Embodiment

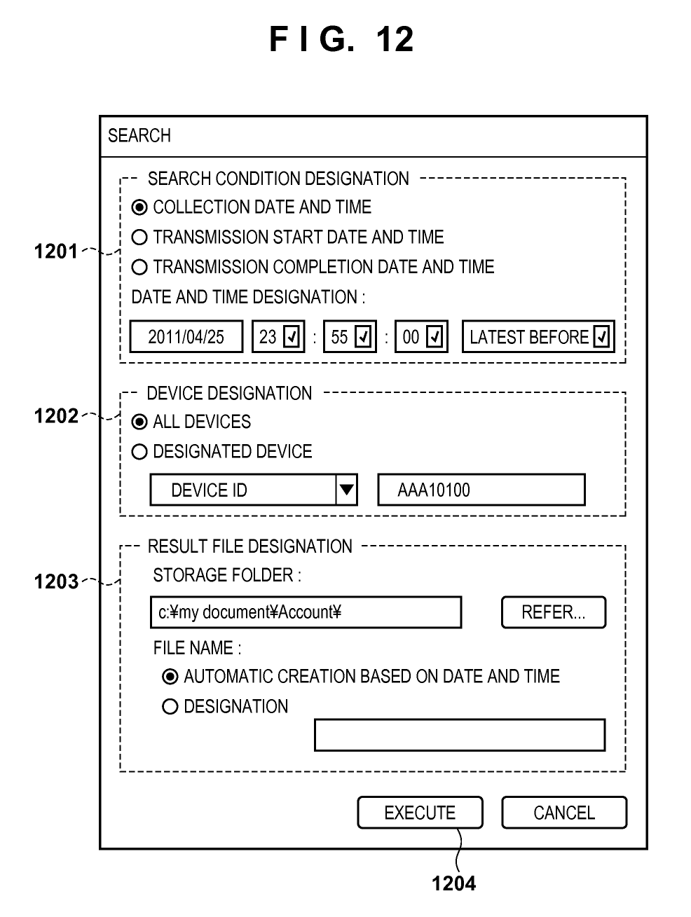

In the first embodiment, a general-purpose application performs a data search. The second embodiment is configured to allow the user to issue a search request as one menu in this system. When the user issues a search request, a search condition acquisition unit 409 of a monitoring apparatus 101 provides a search condition setting UI like that shown in FIG. 12.

The search condition setting UI in FIG. 12 allows search condition designation 1201, device designation 1202, and result file designation 1203 to be performed. When performing the search condition designation 1201, the user selects one of the selection items “collection date and time”, “transmission start date and time”, and “transmission completion date and time”, which are pieces of date and time information, in search data by using a radio button. With regard to the selected date and time item, the user selects a year, month, and day, time, and search condition designation in the date and time designation field. The search condition designation 1201 is configured to allow the user to designate, for example, a date and time and a condition such as “latest before”, “latest after”, or “just”. In this case, the selectable items are not limited to those described above, and may include other setting items as long as they are items that can be determined by using a date and time.

With regard to the device designation 1202, the user can select “all devices” or “designated device”. Designated device information can be configured to allow the user to select a device ID, product name, or IP address in the case shown in FIG. 11. This item may be configured to allow to select a plurality of devices.

In the result file designation 1203, the user designates a storage folder name and a file name as pieces of information indicating a storage destination for a search result. The file name field can be configured to allow to select “automatic creation based on date” or the like. For example, adding an execution date and time (or condition date and time) to at file name will specify a file name.

Pressing an execution button 1204 on the search condition setting UI shown in FIG. 12 will execute search processing. This search processing procedure is the same as that shown in FIG. 8, and will be described below.

### [Search Processing]

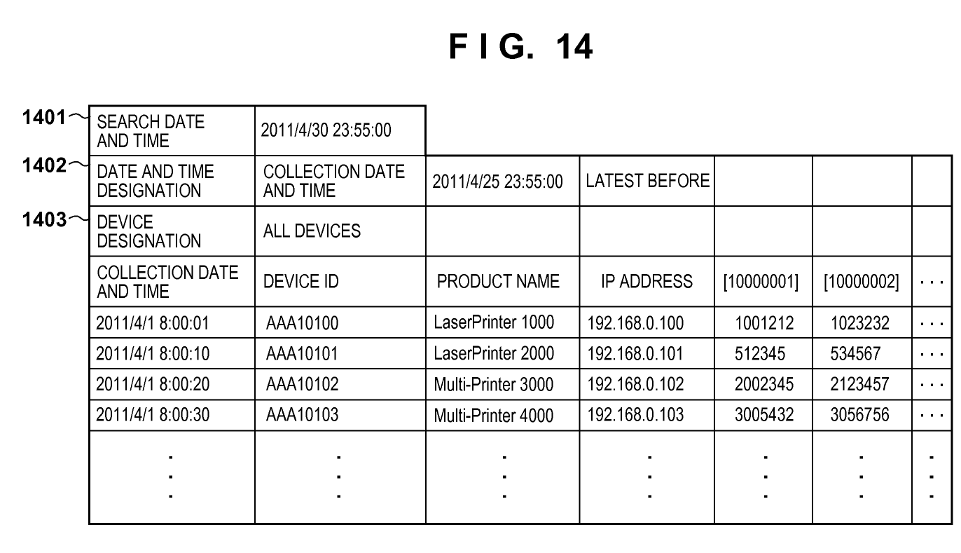

The monitoring apparatus 101 acquires (opens) output data from the storage folder in the output files as a search data (step S801). The monitoring apparatus 101 acquires search conditions set via the search condition setting UI shown in FIG. 12 (step S802), and searches a predetermined folder for data matching the search conditions (step S803). The monitoring apparatus 101 then outputs the search result with the folder and file name designated by the result file designation 1203 designated via the search condition setting UI in FIG. 12 (step S804). The search result can be configured as shown in, for example, FIG. 14. The search result in FIG. 14 is a display example of a list of the date and time designation, device designation condition, and monitoring information of devices as search hits, which are designated on the UI in FIG. 12.

With these operations, although the first embodiment needs to use the general-purpose search tool (general-purpose application), the second embodiment allows to display a list of necessary data for the user by preparing a tool dedicatee to this data search and allows the user to browse the result.

### Third Embodiment

In the first and second embodiments, search conditions are acquired at the time of execution of a search. The third embodiment is configured to allow to designate a periodic search as one search condition.

FIG. 4B shows a system arrangement according to this embodiment, which is obtained by adding a periodic search execution unit 412 and a search result storing unit 413 to the arrangement shown in FIG. 4A. A description of redundant portions will be omitted.

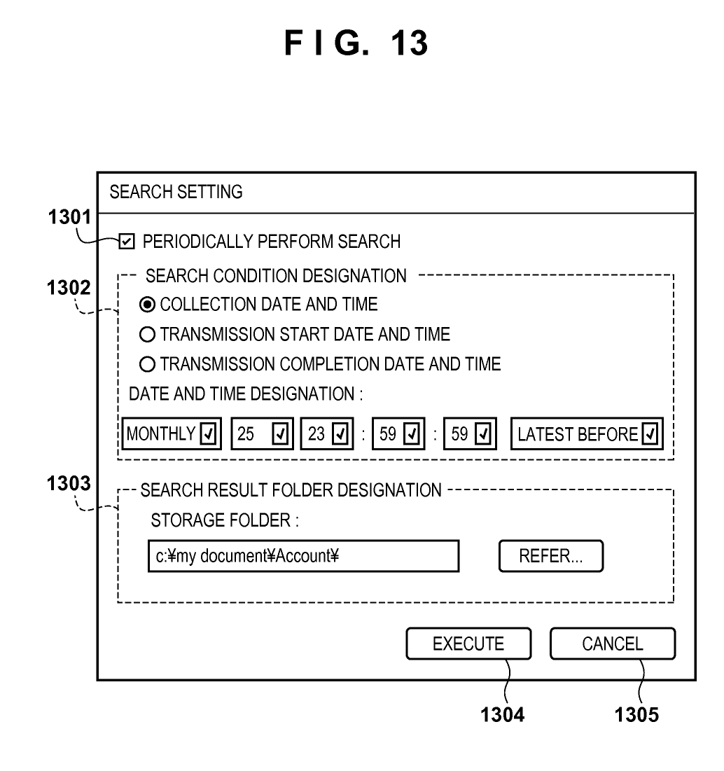

In this embodiment, a search setting UI is configured to allow the user to perform ON/OFF setting of periodic search setting 1301 and periodic search condition setting 1302 when periodic search setting is ON, as one menu of this program. When the user issues a search setting request, the periodic search execution unit 412 of a monitoring apparatus 101 opens the search setting UI shown in FIG. 13.

A search condition acquisition unit 409 of the monitoring apparatus 101 provides the search setting UI shown in FIG. 13 to allow to perform date and time designation and storage folder designation 1303 for a result file. As in the second embodiment, when performing date and time designation, the user selects one of “collection date and time”, “transmission start date and time”, and “transmission completion date and time”, which are pieces of date and title information, in search data by using a radio button. With regard to the selected date and time, the user selects date and time and search condition designation for the execution of periodic search. For example, “date and time designation” is configured to allow to designate conditions such as “every month”, “every week”, “even-numbered months”, and “odd-numbered months”. As in the second embodiment, the search condition designation is configured to allow the user to designate, for example, a condition such as the designated date and time “latest before”, “latest after”, or “just”.

In the storage folder designation 1303 for a result file, the user designates a storage folder name indicating the specific storage location of a search result file. A file name is automatically created based on the execution date and time (or condition date and time). Pressing an update button 1304 of the search setting UI shown in FIG. 13 will update the search schedule.

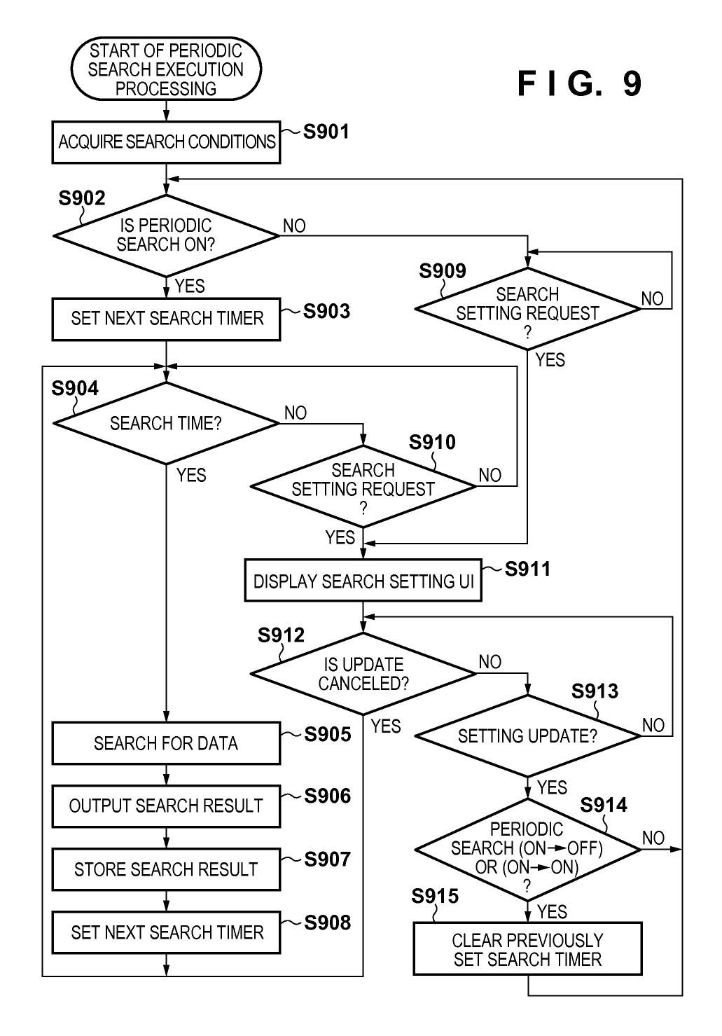

FIG. 9 shows periodic search execution processing by the periodic search execution unit 412 of the monitoring apparatus 101. This processing will be described in detail below. Assume that the processing starts when the system starts up.

The periodic search execution unit 412 or the monitoring apparatus 101 acquires search conditions which have already been set by the search condition input UI or the like (step S901). The periodic search execution unit 412 determines whether the periodic search setting (corresponding to the periodic search setting 1301 in FIG. 13) in the acquired search conditions is “ON” (step S902). If the periodic search setting is “ON” (YES in step S902), the periodic search execution unit 412 calculates the next search execution date and time from the search conditions, and sets a timer for the execution of a search (step S903). After step S903, the periodic search execution unit 412 determines whether the search time has come (the timer is set in a signaling state) (step S904). If the search time has come (YES in step S904), the periodic search execution unit 412 searches the storage folder in the output files for data matching the search conditions (step S905).

The periodic search execution unit 412 then outputs a search result file to the folder designated by the storage folder designation 1303 for the result file which is designated via the search setting UI shown in FIG. 13 (step S906). A search result storing unit 413 of the monitoring apparatus 101 stores the search result tile (step S907).

A search result file can have, for example, an arrangement like that shown in FIG. 14. An example of the arrangement of a search result file shown in FIG. 14 includes search date and time 1401 on the first row, date and time designation 1402 on the second row, and device designation 1403 on the third row. The pieces of subsequent information are identical to the data type 1103 and data 1104 shown in FIG. 11, and hence a description of them will be omitted. Note that the file arrangement to be used is not limited to this.

After step S907, the monitoring apparatus 101 calculates a search execution date and time from the search conditions in the same manner as in step S903, and sets the timer for the execution of a search (step S903). After step S908, the process returns to step S904.

If NO in step S902 or S904, the monitoring apparatus 101 determines whether there is a search setting request (step S909 or S910). If YES in step S909 or S910, the monitoring apparatus 101 displays the search setting UI shown in FIG. 13 via a display unit 321 (step S911). If the monitoring apparatus 101 determines in step S909 that there is no search setting request (NO in step S909), the monitoring apparatus 101 stands by until a search setting request is received. If the monitoring apparatus 101 determines in step S910 that there is no search setting request (NO in step S910), the process returns to step S904.

After step S911, the monitoring apparatus 101 determines whether the user has designated update cancellation via the search setting UI in FIG. 13 (step S912). The user performs cancellation designation by pressing a cancel button 1305 on the search setting UI in FIG. 13. If the user has designated update cancellation (YES in step S912), the process returns to step S904. If the user has not designated update cancellation (NO in step S912), the monitoring apparatus 101 determines whether the user has designated setting update via the search setting UI in FIG. 13 (step S913). The user performs update designation by pressing an update button 1304 on the search setting UI in FIG. 13. If the user has designated setting update (YES in step S913), the monitoring apparatus 101 determines whether the user has changed periodic search designation (periodic search setting 1301) from “ON” to “YES” or determines whether the user keeps periodic search designation “ON” (step S914). If YES in step S914, since the previously set search timer is invalid, the monitoring apparatus 101 clears the timer (step S915). If NO in step S914 or after step S915, the process returns to step S902. If the user has issued no setting update instruction (NO in step S913), the process returns to step S912,

With the above operation, in contrast to the first and second embodiments in which the user needs to issue a search instruction for each search, the third embodiment is configured to periodically execute a search by using a created file, thereby obtaining the effect of reducing the user's labor of issuing instructions.

### Fourth Embodiment

The third embodiment is configured to acquire periodic search conditions by user designation. In contrast, in the fourth embodiment, a periodic search execution unit 412 of a monitoring apparatus 101 acquires periodic search conditions from a central management apparatus 106. When, for example, the user wants to specify monthly charge data by using the present invention, he/she may acquire a charge date and time as search conditions from the central management apparatus 106. FIG. 4B shows the arrangement of this system, which is the same sis that in the third embodiment. For this reason, a description of redundant portions will be omitted.

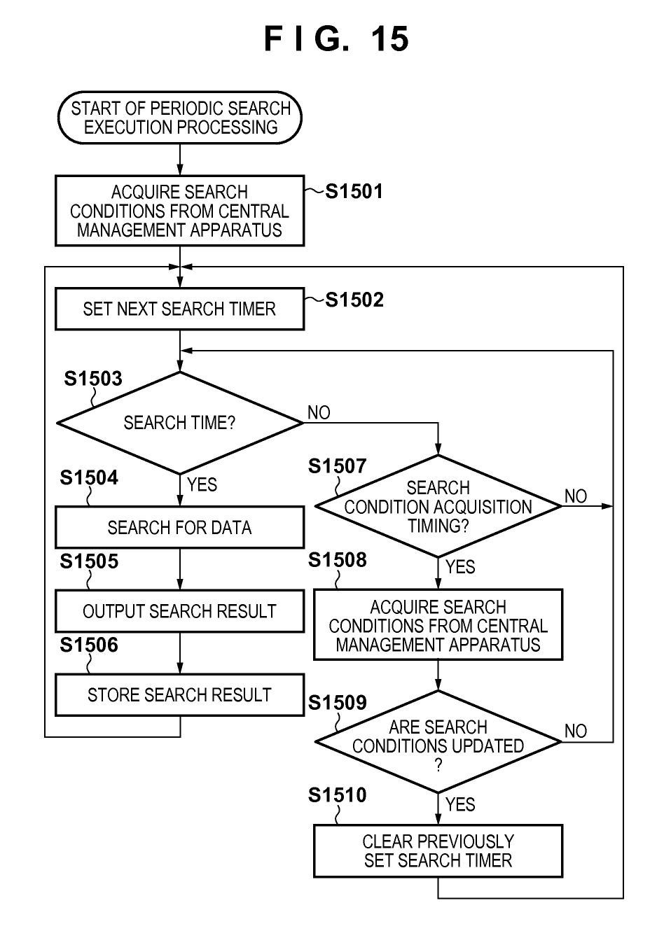

FIG. 15 shows a processing procedure in this embodiment which replaces the periodic search execution processing procedure by the periodic search execution unit 412 in the third embodiment. This processing will be described in detail below. Assume that the processing starts when the system starts up.

First of all, the monitoring apparatus 101 acquires search conditions from the central management apparatus 106 (step S1501). The monitoring apparatus 101 then calculates the next search execution date and time from the acquired search conditions, and sets a timer for the execution of a search (step S1502). After step S1502, the monitoring apparatus 101 determines whether the search time has come (the timer is set in a signaling state) (step S1503). If the search time has come (YES in step S1503), the monitoring apparatus 101 searches the storage folder in the output files for data matching the search conditions (step S1504).

The monitoring apparatus 101 then outputs a search result to the folder determined by system setting (step S1505). The monitoring apparatus 101 causes a search result storing unit 413 to store the result file (step S1506). The search result file can have an arrangement like, for example, that shown in FIG. 14 as in the third embodiment.

If the search time has not come (NO in step S1503), the monitoring apparatus 101 determines whether the current timing is the timing at which search conditions are periodically acquired from the central management apparatus 106 (step S1507). For example, this embodiment is configured to detect a change in search conditions in the central management apparatus 106 by periodically acquiring search conditions from the central management apparatus 106. If the current timing is the timing at which search conditions are acquired (YES in step S1507), the monitoring apparatus 101 acquires search conditions from the central management apparatus 106 (step S1508). The monitoring apparatus 101 determines whether the search conditions acquired in step S1508 are updated (step S1509). If search conditions are updated (YES in step S1509), since the previously set search timer becomes invalid, the monitoring apparatus 101 clears the value of the search timer (step S1510).

If NO in step S1507 or S1509, the process returns to step S1503, After step S1506 or S1510, the process returns to step S1502.

With the above operation, in contrast to the third embodiment in which the user needs to set search conditions, the fourth embodiment is configured to acquire search conditions from the central management apparatus 106. This makes it possible to reduce the user's labor of issuing instructions.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2011-129547, filed Jun. 9, 2011, which is hereby incorporated by reference herein in its entirety.

What is claimed is:

1. A monitoring apparatus which monitors a plurality of image forming apparatuses and transmits monitoring information, collected by monitoring, to a central management apparatus which manages information of the plurality of image forming apparatuses, comprising:
collection unit configured to collect the monitoring information from the plurality of image forming apparatuses;
storing unit configured to store the monitoring information collected by said collection unit;
transmission unit configured to transmit the monitoring information stored by said storing unit to the central management apparatus;
selection unit configured to accept selection of a data type, of the collected monitoring information, which is stored in a storage device within a local network; and
output configured to output, as output data, data acquired from the monitoring information transmitted by said transmission unit in accordance with the data type selected by said selection unit for storing the output data in the storage device within the local network.

2. The apparatus according to claim 1, wherein said output unit outputs the output data for each transmission of monitoring information to the central management apparatus.

3. The apparatus according to claim 1, wherein said output unit further adds a search data item and a value thereof to the output data.

4. The apparatus according to claim 3, further comprising time acquisition unit configured to acquire time information,
wherein said time acquisition unit acquires information of a time at which said collection unit has collected the monitoring information from an image forming apparatus,
said storing unit stores the monitoring information collected by said collection unit in correspondence with the information of the time, and
said output unit outputs the search data item and a value thereof with the information of the time being added thereto.

5. The apparatus according to claim 3, further comprising time acquisition unit configured to acquire information of a time,
wherein said time acquisition unit acquires information of a time at which the monitoring information is transmitted to the central management apparatus,
said storing unit stores the monitoring information collected by said collection unit in correspondence with the information of the time, and
said output unit outputs the search data item and a value thereof with the information of the time being added thereto.

6. The apparatus according to claim 1, wherein the output data is stored in a file in a CSV (Comma Separated Values) format in the local network.

7. The apparatus according to claim 1, wherein the output data is stored in a database in the local network to which the monitoring apparatus belongs.

8. The apparatus according to claim 1, wherein said selection unit accepts selection of the data type via a user interface or a setting file.

9. The apparatus according to claim 1, wherein the data type includes a type of data associated with processing, of processing executed by the plurality of image forming apparatuses, which becomes a charge target.

10. The apparatus according to claim 4, wherein when the output data is browsed, the search data item and the value thereof which are added to the output data are used as search conditions.

11. The apparatus according to claim 4, wherein the search data item is acquired from the central management apparatus.

12. The apparatus according to claim 4, wherein the search data item is acquired via a user interface or a setting file.

13. A monitoring method for a monitoring apparatus which monitors a plurality of image forming apparatuses and transmits monitoring information, collected by monitoring, to a central management apparatus which manages information of the plurality of image forming apparatuses, comprising the steps of:
collecting the monitoring information from the plurality of image forming apparatuses;
storing the collected monitoring information in a storing unit;
transmitting the stored monitoring information to the central management apparatus;
accepting selection of a data type, of the collected monitoring information, which is stored in a storage device within a local network; and
outputting data acquired from the transmitted monitoring information in accordance with the selected data type as output data for storing the output data in the storage device within the local network.

14. A computer-readable medium storing a program for causing a computer to function as each unit defined in claim 1.
